(19) United States
(12) Patent Application Publication
(10) Pub. No.: US 2026/0024187 A1
(43) Pub. Date: Jan. 22, 2026

(54) IMAGE OUTPUT DEVICE AND IMAGE OUTPUT SYSTEM

(71) Applicant: FUJI CORPORATION, Chiryu (JP)

(72) Inventors: Mikio NAKAJIMA, Toyokawa-shi (JP); Masafumi AMANO, Okazaki-shi (JP)

(73) Assignee: FUJI CORPORATION, Chiryu (JP)

(21) Appl. No.: 18/993,914

(22) PCT Filed: Aug. 4, 2022
(86) PCT No.: PCT/JP2022/029992

§ 371 Date: Jan. 13, 2025

(51) Int. Cl. G06T 7/00; G06T 11/00

(52) U.S. Cl. CPC G06T 7/0004; G06T 11/00; G06T 2207/20092; G06T 2207/30152

(57) ABSTRACT

An image processing device includes an acquisition section configured to acquire original images and accompanying information including a result of image processing performed on the original images as information accompanying the original images, a generation section configured to generate in advance a thumbnail image of an original image selected based on the accompanying information among the original images acquired by the acquisition section and to generate, in response to a request, thumbnail images of original images which have not been generated in advance, and an output section configured to output the thumbnail image generated by the generation section in response to a request.

### TECHNICAL FIELD

The present description relates to an image output device and an image output system.

### BACKGROUND ART

Conventionally, in a recording and reproducing device that creates thumbnails of AV data recorded in an HD or a DVD and stores the created thumbnails in a cache area of the HD, there has been proposed a recording and reproducing device that preferentially creates thumbnails having a high display possibility (for example, see Patent Literature 1). In this recording and reproducing device, AV data is recorded on the HD or the DVD in title units or chapter units, and when a title video selection screen is displayed, it is determined that there is a high possibility of displaying thumbnails to be displayed during screen transition to a chapter video selection screen, and the thumbnails are created in advance. When the chapter video selection screen is displayed, the thumbnails to be displayed during the screen transition to the title video selection screen are generated in advance.

### CITATION LIST

### Patent Literature

Patent Literature 1: JP-A-2005-252790

### BRIEF SUMMARY

### Technical Problem

The technique described in Patent Literature 1 can be applied to a case where thumbnails of images for which screen transition is performed in a pre-determined mode, such as AV data recorded in title units or chapter units, are created in advance, but cannot be applied to a case where thumbnails of images that are variously required among multiple images are created in advance.

A main object of the present disclosure is to increase the speed of output of thumbnail images in response to a request by generating the thumbnail images in advance, and to further reduce a load when creating the thumbnail images in advance.

### Solution to Problem

The present disclosure employs the following means in order to achieve the main purpose described above.

An image output device according to the present disclosure includes:
an acquisition section configured to acquire original images and accompanying information including a result of image processing performed on the original images as information accompanying the original images;
a generation section configured to generate in advance a thumbnail image of an original image selected based on the accompanying information among the original images acquired by the acquisition section and to generate, in response to a request, thumbnail images of original images which have not been generated in advance; and
an output section configured to output the thumbnail image generated by the generation section in response to a request.

In the image output device according to the present disclosure, the original images and the accompanying information including the result of the image processing performed on the original images are acquired, and the thumbnail image of the original image selected based on the accompanying information among the acquired original images is generated in advance. When the result of the image processing is used to select an image to be confirmed later, a user can create in advance a thumbnail image of an original image that is highly likely to be requested to be output based on accompanying information including the result of the image processing. As a result, it is possible to speed up the output of the thumbnail image in response to the request by generating the thumbnail image in advance. In addition, as compared to a case where thumbnail images are generated for all the acquired original images, it is possible to further reduce a load when creating the thumbnail images in advance.

An image output system of the present disclosure includes:
an imaging section provided in an inspection device and configured to capture original images of an inspection object;
an image processing section configured to perform image processing on the original images of the inspection object captured by the imaging section and inspect the inspection object;
an acquisition section configured to acquire the original images of the inspection object captured by the imaging section and accompanying information including an inspection result of the inspection object by the image processing section as information accompanying the original images;
a generation section configured to generate in advance a thumbnail image of an original image selected based on the accompanying information among the original images of the inspection object acquired by the acquisition section and to generate, in response to a request, thumbnail images of original images which have not been generated in advance; and
an output section configured to output the thumbnail images generated by the generation section in response to a request.

The image output system of the present disclosure can achieve the same effect as that of the image output device of the present disclosure.

### BRIEF DESCRIPTION OF DRAWINGS

FIG. 1 is a schematic configuration diagram of a production system including an image output system of the present embodiment.

FIG. 2 is a view illustrating an example of a module constituting the production system.

FIG. 3 is a flowchart illustrating an example of image reception processing executed by a management device.

FIG. 4 is a flowchart illustrating an example of image display processing executed by the management device.

FIG. 5 is a view illustrating an example of display information displayed on a display device.

### DESCRIPTION OF EMBODIMENTS

Next, an embodiment of the present disclosure will be described with reference to the drawings.

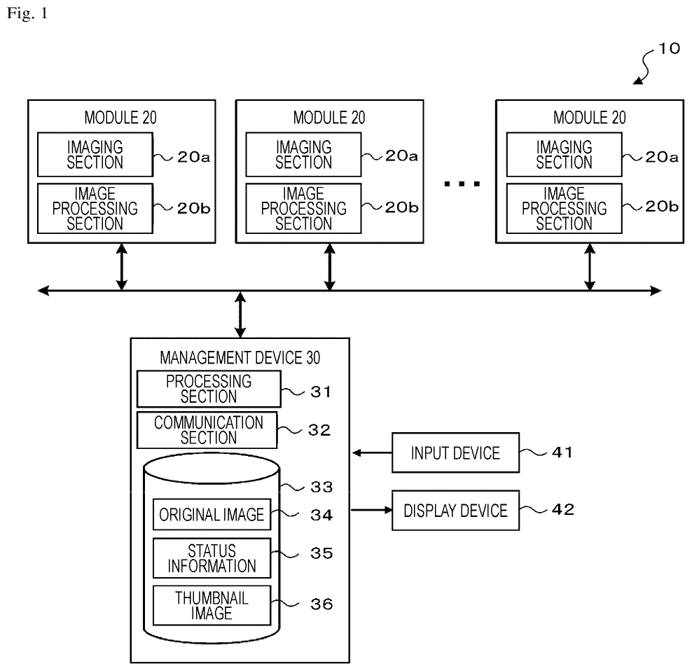

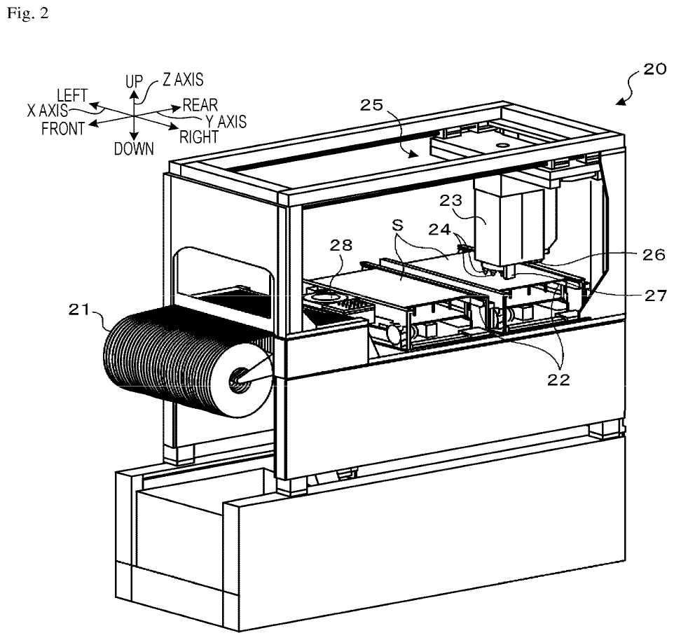

FIG. 1 is a schematic configuration diagram of production system 10 including an image output system of the present embodiment. FIG. 2 is a view illustrating an example of module 20 constituting the production system. As illustrated, production system 10 produces a board on which components are mounted, and includes multiple modules 20 and management device 30 that manages multiple modules 20.

Multiple modules 20 include a printing machine, a print inspection machine, a component mounter, a mounting inspection machine, and the like. Here, the printing machine forms a circuit pattern by printing solder on a board. The print inspection machine captures an image of the board and inspects whether the solder is normally printed on the board. The component mounter takes out a component from feeder 21 and mounts the component on the board. The mounting inspection machine captures an image of the board and inspects whether the component is normally mounted on the board. Each module 20 includes imaging section 20a that captures an image of an inspection object (for example, a board, solder, or a component), and image processing section 20b that processes the image of the inspection object captured by imaging section 20a to perform necessary inspection or confirmation.

As illustrated in FIG. 2, the component mounter as one of modules 20 includes feeder 21 as a component supply device that supplies a component, board conveyance device 22 that conveys a board, head 23 that picks up the component supplied to a component supply position from feeder 21 by suction nozzle 24 (pickup member) that is vertically movable, and mounts the component on the board, and head moving device 25 that horizontally moves head 23. In the present embodiment, head 23 holds multiple suction nozzles 24, and can pick up multiple components at a time using multiple suction nozzles 24 and mount the components on the board in one cycle from pick up to mounting of the components. Further, the component mounter includes mark camera 26, side camera 27, and part camera 28 as imaging section 20a.

Mark camera 26 is configured to be movable together with head 23 by head moving device 25, and captures an image of the upper surface of the component supplied by feeder 21 from above, captures an image of the upper surface of the board conveyed by board conveyance device 22 from above, and captures an image of the upper surface of the board on which the component is mounted by head 23 from above. The image (original image) captured by mark camera 26 is output to image processing section 20b.

Side camera 27 is installed on head 23, and captures an image of the vicinity of the tip portion of suction nozzle 24 from the side when the component is being picked up by suction nozzle 24. The image (original image) captured by side camera 27 is output to image processing section 20b.

Part camera 28 is installed between feeder 21 and board conveyance device 22, and captures an image of the component from below when suction nozzle 24 that has picked up the component passes overhead. The image (original image) captured by part camera 28 is output to image processing section 20b.

Image processing section 20b acquires images captured by mark camera 26, side camera 27, and part camera 28 and performs image processing on each of the acquired images. Specifically, as image processing for the image captured by mark camera 26, image processing section 20b acquires an image of the board captured by mark camera 26 when the board is conveyed by board conveyance device 22, and processes the acquired image to confirm the position of the board. In addition, when the component supplied to the component supply position by feeder 21 is picked up by suction nozzle 24, image processing section 20b processes the image of the component supply position captured by mark camera 26 to confirm the presence or absence of the component and the position of the component at the component supply position. Further, after the component is mounted on the board, image processing section 20b acquires an image of the board captured by mark camera 26, and processes the acquired image to confirm a mounting deviation amount (a positional deviation amount and an angular deviation amount) of the component with respect to the board.

In addition, as image processing for the image captured by side camera 27, image processing section 20b acquires an image of the vicinity of the tip portion of suction nozzle 24 captured by side camera 27 when the component is being picked up by suction nozzle 24, and processes the acquired image to confirm whether the component is being picked up by suction nozzle 24 and the pickup posture.

Further, as image processing for the image captured by part camera 28, image processing section 20b acquires an image captured by part camera 28 when suction nozzle 24 that has picked up the component passes above part camera 28, and processes the acquired image to confirm a suction deviation amount (a positional deviation amount and an angular deviation amount) of the component with respect to suction nozzle 24.

The image processing result in image processing section 20b is transmitted to management device 30 together with the original image as information (status information) accompanying the original image. For example, when an image of the component (target component) picked up by suction nozzle 24 is captured by part camera 28, the image processing result includes a positional deviation amount (X coordinate value, Y coordinate value) and an angle deviation amount (θ angle value) of the target component with respect to suction nozzle 24 specified by the image processing, information (presence or absence of an error and an error code) indicating whether the positional deviation amount and the angle deviation amount are within an allowable range, and the like. When an image of the component (target component) mounted on the board is captured by mark camera 26, the image processing result includes a positional deviation amount (X coordinate value, Y coordinate value) and an angle deviation amount (θ angle value) of the target component with respect to the board specified by the image processing, information (presence or absence of an error and an error code) indicating whether the positional deviation amount and the angle deviation amount are within an allowable range, and the like. The status information includes parameters (image processing conditions) necessary for image processing and other information in addition to the image processing result described above. The image processing conditions include, for example, shape data including an outer shape of the component and tolerance data that is an allowable range of a positional deviation amount and an angular deviation amount of the component, capturing conditions (such as a camera and a light source used for capturing), calibration data (such as a distortion correction value of the camera), and the like. Other information includes, for example, the capture date and time of the original image, information (component type information) specifying the type of the target component, information (board type information) specifying the type of the board on which the target component is mounted, information (feeder information) specifying feeder 21 used to supply the target component, information (head information) specifying head 23 used to pick up and mount the target component, and information (nozzle information) specifying suction nozzle 24 used to pick up the target component.

Management device 30 manages a production line. Management device 30 acquires and stores the original images captured by imaging section 20a from each module 20 of the production line, and outputs (displays) the original images in response to a request from the user. Management device 30 includes processing section 31, communication section 32, and storage section 33. In addition, input device 41 such as a mouse and a keyboard and display device 42 for displaying various information are connected to management device 30.

Processing section 31 is configured as a microprocessor centered on CPU, and includes ROM storing a processing program, RAM temporarily storing data, and the like in addition to the CPU. Communication section 32 is communicably connected to multiple modules 20 constituting the production line, and exchanges various information with multiple modules 20.

Storage section 33 is configured as a storage device such as a hard disk drive or a solid state drive. Storage section 33 stores original image 34, status information 35, thumbnail image 36, and the like. Original image 34 is captured by imaging section 20a (such as mark camera 26, side camera 27, and part camera 28), and is acquired from corresponding module 20 through communication. In the present embodiment, all images captured during production in the production line are stored in storage section 33. Status information 35 includes an image processing result, image processing conditions, and other information, and is acquired through communication from corresponding module 20 together with original image 34 as information accompanying original image 34. Thumbnail image 36 is generated from an original image in image reception processing or image display processing, which will be described later, and is stored.

Next, operations of the image output system and the image output device of the present embodiment included in the production line configured as described above will be described. Here, the image output system of the present embodiment corresponds to imaging section 20a and image processing section 20b provided in each module 20, and management device 30, and the image output device of the present embodiment corresponds to management device 30.

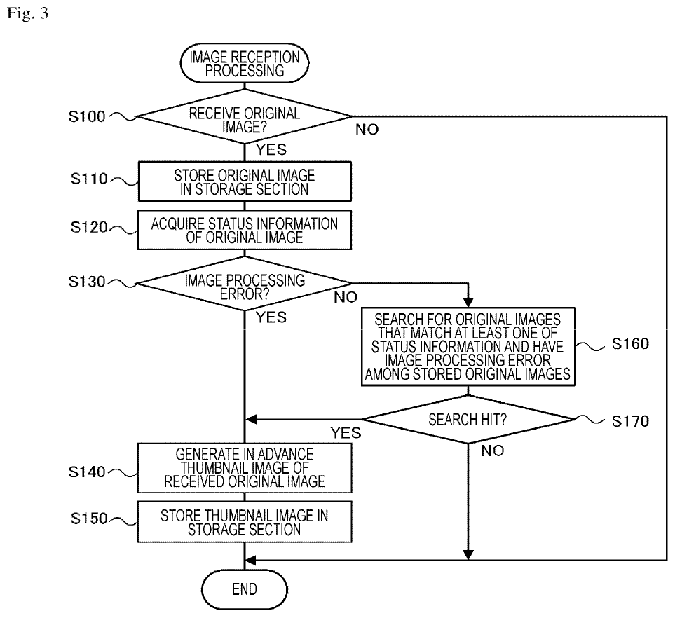

FIG. 3 is a flowchart illustrating an example of image reception processing executed by processing section 31 of management device 30. This processing is repeatedly executed every predetermined time period. When image reception processing is executed, processing section 31 first determines whether an original image is received from module 20 (S100). When it is determined that the original image has not been received, processing section 31 ends the image reception processing without further operations.

When it is determined that the original image has been received, processing section 31 stores the received original image in storage section 33 (S110). Subsequently, processing section 31 acquires an image processing result accompanying the original image (S120), and based on information included in the acquired image processing result, determines whether the acquired image processing result indicates an error, that is, whether the acquired image processing result is an abnormal result (S130). When it is determined that the image processing result indicates an error, processing section 31 generates in advance a thumbnail image of the original image received in S100, that is, a thumbnail image of the abnormal image determined to have an image processing result indicating an error (S140), stores the thumbnail image generated in advance in storage section 33 in association with the received original image (S150), and ends the image reception processing.

On the other hand, when it is determined that the image processing result of the original image received in S100 does not indicate an error but normal, processing section 31 searches for original images 34 that are highly relevant to the original image received in step S100 among other original images 34 stored in storage section 33, focusing on original images 34 having an image processing result indicating an error (S160). In the present embodiment, this processing is performed by searching for original images 34 among original images 34 having an image processing result indicating an error, where at least one of the image processing conditions is common. For example, when searching for other original images that are highly relevant to the original image obtained by capturing an image of the target component, other original images include an original image obtained by capturing an image of other components picked up by head 23 (multiple suction nozzles 24) in the same cycle as the target component, an original image obtained by capturing an image of other components having the same shape as the target component, an original image obtained by capturing an image of the target component with another camera, and the like. When it is determined that there are other original images 34 that are highly relevant to the original image among original images 34 having an image processing result indicating an error (YES in S170), processing section 31 generates in advance a thumbnail image of the original image received in S100 (S140), stores the thumbnail image generated in advance in storage section 33 (S150), and ends the image reception processing. On the other hand, when it is determined that there are no other original images 34 that are highly relevant to the original image (NO in S170), processing section 31 ends the image reception processing without generating thumbnail images in advance.

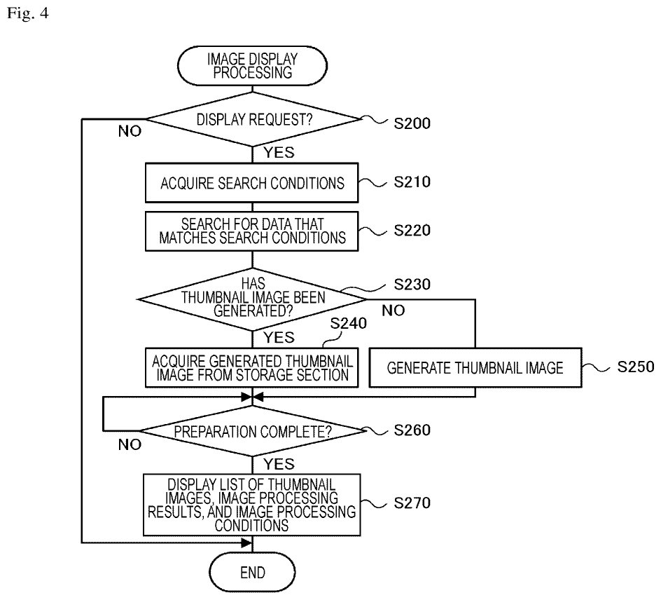

Next, image display processing performed in response to a request from the user after a large number of original images 34 (including status information 35) are stored in storage section 33 will be described. FIG. 4 is a flowchart illustrating an example of image display processing executed by processing section 31 of management device 30.

When the image display processing is executed, processing section 31 of management device 30 first determines whether a display request has been made by the user through the operation of input device 41 (S200). When it is determined that the display request has not been made, processing section 31 ends the image display processing.

When it is determined that the display request has been made, processing section 31 acquires search conditions specified by the user (S210). From original images 34 stored in storage section 33, original images 34 that match the specified search conditions are searched (S220). As search conditions, examples include an image captured at a specified date and time, an image of a specified component type, an image of a specified board type, an image of a specified nozzle, an image of a specified camera, and an image in which an image processing error occurred with a specified error code.

Next, processing section 31 determines whether thumbnail images 36 have been generated for original images 34 that match the search conditions (S230). When it is determined that thumbnail images 36 have been generated, processing section 31 acquires generated thumbnail images 36 from storage section 33 (S240), and when it is determined that thumbnail images 36 have not been generated, processing section 31 generates thumbnail images 36 of original images 34 that match the search conditions (S250). After generating thumbnail images 36, processing section 31 stores generated thumbnail images 36 in storage section 33 in association with original images 34. Then, processing section 31 waits until the preparation of thumbnail images 36 are completed (S260). When it is determined that the preparation of thumbnail images 36 are completed, processing section 31 displays a list of thumbnail images 36 together with corresponding status information 35 on display device 42 (S270), and ends the image display processing. The display of a list of thumbnail images 36 may be performed at once when acquisition of all thumbnail images 36 to be displayed on the same screen is completed, or may be performed in order from acquired thumbnail images 36.

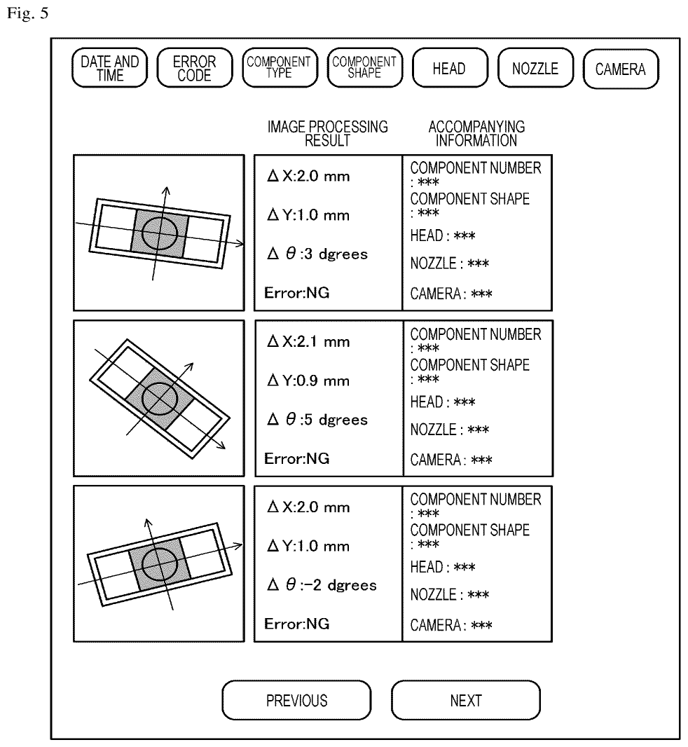

FIG. 5 illustrates an example of display information displayed on display device 42. As illustrated in FIG. 5, the display information includes a thumbnail image of the original image, an image processing result (for example, information such as a positional deviation amount, an angle deviation amount, and presence or absence of an error), and other information (for example, component type information, a component shape, head information, nozzle information, and camera information). For example, the display information is displayed in a list up to a predetermined number (for example, three) in one screen, proceeds to the next screen as a next button is operated, and returns to the previous screen as a previous button is operated. The display information also includes a filter button for narrowing down the data to be displayed by specifying filter conditions. The filter button includes options for specifying the capture date and time, specifying the error code of the image processing, specifying the component, specifying the component shape, specifying used head 23, specifying used suction nozzle 24, specifying the used camera, and the like. When the user operates the filter button, processing section 31 searches for data under the filter conditions corresponding to the filter button, and displays thumbnail images 36 and status information 35 of the data that match the filter conditions on display device 42.

Here, when an error occurs in the production line during production, in order to specify the cause of the error, the user may want to check the images captured by imaging section 20a and having an image processing result indicating an error or images highly related thereto. In this case, the user specifies search conditions and requests management device 30 to perform display, so that it is possible to display a list of thumbnail images of original images having an image processing result indicating an error and original images that are highly relevant thereto on display device 42 together with the information including the image processing result. In the present embodiment, among the original images received from modules 20, processing section 31 of management device 30 generates a thumbnail image of the received original image not only when the image processing result indicates an error but also when other original images 34 match at least one of the image processing conditions with the received original image and have an image processing result indicating an error are stored in storage section 33 even if the image processing result indicates normal. Therefore, in response to a request from the user, it is possible to quickly display thumbnail images of an original image having an image processing result indicating an error and original images that are highly relevant to the original image, and to use the thumbnail images for specifying an error. In addition, compared to a case where thumbnail images of all original images received from each module 20 are generated in advance, it is possible to reduce a load when generating the thumbnail images in advance.

Here, a correspondence relationship between elements of the embodiment and elements of the present disclosure will be described. That is, processing section 31 of the present embodiment that executes S100 to S120 of the image reception processing corresponds to an acquisition section of the present disclosure, processing section 31 that executes S140 of the image reception processing and S250 of the image display processing corresponds to a generation section, and processing section 31 that executes S270 of the image display processing and display device 42 correspond to an output section. Imaging section 20a (mark camera 26, side camera 27, and part camera 28) corresponds to an imaging section, and image processing section 20b corresponds to an image processing section.

It is needless to say that the present disclosure is not limited to the embodiment described above in any way, and hence can be implemented in various aspects as long as the aspects fall within the technical scope of the present disclosure.

For example, in the above-described embodiment, processing section 31 generates in advance a thumbnail image of received original image 34 not only when the image processing result of received original image 34 indicates an error, but also when other original images 34 match at least one of status information 35 (image processing conditions) with received original image 34 and have an image processing result indicating an error are stored in storage section 33 even if the image processing result of received original image 34 indicates normal. However, processing section 31 may generate in advance a thumbnail image only for original image 34 having an image processing result indicating an error among received original images 34, and may generate thumbnail images of other original images 34 in response to a request from the user.

In the above-described embodiment, processing section 31 displays the thumbnail images of original images 34 on display device 42 in response to a request from the user. However, processing section 31 may output information including the thumbnail images to another device or print the information in response to a request from the user.

In addition, in the above-described embodiment, processing section 31 acquires the original images captured by imaging section 20a (mark camera 26, side camera 27, and part camera 28) provided in the component mounter as module 20 together with the status information, and generates in advance a thumbnail image of the original image selected based on the status information among the acquired original images. However, the present disclosure is not limited to the component mounter, and when the original images captured by imaging section 20a are acquired in other modules 20 including imaging section 20a, such as a printing machine, a print inspection machine, or a mounting inspection machine, the thumbnail images may be generated in advance under the same condition.

As described above, in the image output device according to the present disclosure, an original image and accompanying information including a result of image processing performed on the original image are acquired, and a thumbnail image of the original image selected based on the accompanying information among the acquired original images is generated in advance. When the result of the image processing is used to select an image to be confirmed later, the user can create in advance a thumbnail image of the original image that is highly likely to be requested to be output based on accompanying information including the result of the image processing. As a result, it is possible to speed up the output of the thumbnail image in response to the request by generating the thumbnail image in advance. In addition, as compared to a case where thumbnail images are generated for all the acquired original images, it is possible to further reduce a load when creating the thumbnail images in advance.

In the image output device according to the embodiment of the present disclosure, the generation section may generate in advance the thumbnail image of an abnormal image that is at least an original image, for which an abnormal result is obtained as a result of the image processing, among the original images acquired by the acquisition section. In this way, when the user intends to confirm the original image for which an abnormal result is obtained as a result of the image processing, the thumbnail image can be quickly output. In this case, the accompanying information may include image processing conditions for performing the image processing, and the generation section may generate in advance the thumbnail image of an original image, for which a normal result is obtained as a result of the image processing and at least one of the image processing conditions is common to the abnormal image, among the original images acquired by the acquisition section. In this way, when the user confirms not only the original image for which an abnormal result is obtained as a result of the image processing but also the relevant normal original image, the thumbnail images can be quickly output.

The present disclosure is not limited to the form of an image output device, and may take the form of an image output system including an imaging section and an image processing section in addition to the image output device.

### INDUSTRIAL APPLICABILITY

The present disclosure is applicable to a manufacturing industry of an image output device and an image output system.

### REFERENCE SIGNS LIST

10: production system, 20: module, 20a: imaging section, 20b: image processing section, 21: feeder, 22: board conveyance device, 23: head, 24: suction nozzle, 25: head moving device, 26: mark camera, 27: side camera, 28: part camera, 30: management device, 31: processing section, 32: communication section, 33: storage section, 34: original image, 35: status information, 36: thumbnail image, 41: input device, 42: display device.

1. An image output device comprising:
an acquisition section configured to acquire original images and accompanying information including a result of image processing performed on the original images as information accompanying the original images;
a generation section configured to generate in advance a thumbnail image of an original image selected based on the accompanying information among the original images acquired by the acquisition section and to generate, in response to a request, thumbnail images of original images which have not been generated in advance; and
an output section configured to output the thumbnail image generated by the generation section in response to a request.

2. The image output device according to claim 1, wherein the generation section generates in advance the thumbnail image of an abnormal image that is at least an original image, for which an abnormal result is obtained as a result of the image processing, among the original images acquired by the acquisition section.

3. The image output device according to claim 2,
wherein the accompanying information includes image processing conditions for performing the image processing, and
the generation section generates in advance the thumbnail image of an original image, for which a normal result is obtained as a result of the image processing and at least one of the image processing conditions is common to the abnormal image, among the original images acquired by the acquisition section.

4. An image output system comprising:
an imaging section provided in an inspection device and configured to capture original images of an inspection object;
an image processing section configured to perform image processing on the original images of the inspection object captured by the imaging section and inspect the inspection object;
an acquisition section configured to acquire the original images of the inspection object captured by the imaging section and accompanying information including an inspection result of the inspection object by the image processing section as information accompanying the original images;
a generation section configured to generate in advance a thumbnail image of an original image selected based on the accompanying information among the original images of the inspection object acquired by the acquisition section and to generate, in response to a request, thumbnail images of original images which have not been generated in advance; and
an output section configured to output the thumbnail images generated by the generation section in response to a request.
